(19) United States
(12) Patent Application Publication
(10) Pub. No.: US 2003/0172272 A1
(43) Pub. Date: Sep. 11, 2003

(54) Authentication system and method

(76) Inventors: Gavin Walter Ehlers, Pretoria (ZA); Walter Bam Smuts, Pretoria (ZA)

Correspondence Address: LADAS & PARRY, 224 SOUTH MICHIGAN AVENUE, SUITE 1200, CHICAGO, IL, 60604, US

(21) Appl. No.: 10/296,364

(22) PCT Filed: May 23, 2001
(86) PCT No.: PCT/IB01/00903

(30) Foreign Application Priority Data
May 24, 2000 (ZA) 2000/2559

(51) Int. Cl. H04L 9/00

(52) U.S. Cl. 713/170

(57) ABSTRACT

An authentication system (10) allows the identity of a user (12) to be authenticated when the user (12) is seeking access to a secure service provided by a server (14). The system (10) comprises two separate communications channels. The first channel is a network (20) for allowing the user (12) to communicate with the server (14). The second channel is a mobile communications channel (26) that utilises a mobile communications device (28) for allowing an authentication server (22) to communicate with the user (12). In use when the user (12) requests access to the server (14), he or she sends a username to the server (14). The server (14) generates a request for the confirmation of the user's identity, which it sends to the authentication server (22). The authentication server (22) in turn generates a passcode and also queries a user database for the mobile communication device network number of the user (12). The server (22) sends the passcode via the mobile communication network to the user's mobile device (28) and to the server (14). Once the user (12) receives the passcode, he or she offers it as a passcode to the server (14), which compares the passcode that was offered by the user (12) with the passcode that it received from the authentication server (22). If the two codes are the same, the server (14) may allow access to the desired service or facility.

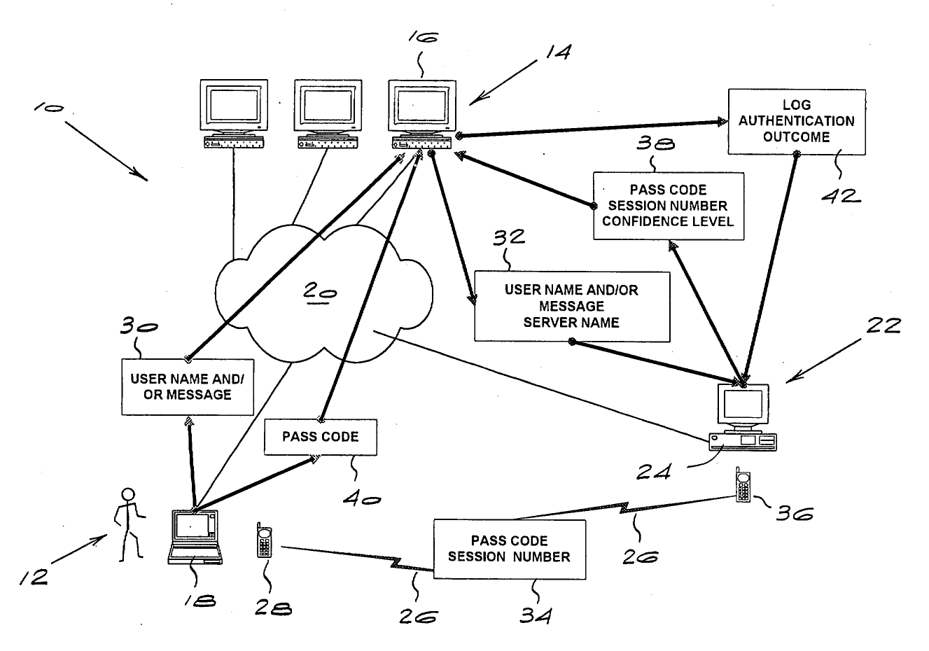

### BACKGROUND OF THE INVENTION

THIS invention relates to an authentication system and method, and in particular to a system for and method of authenticating a user's identity by using a mobile communication device as an authentication token.

Typical systems for allowing a user to access a secure service are computer-based systems comprising client and server computers. There are, however, three fundamental concerns when users need to utilise these systems, namely the authentication of the user (and/or client computer) making use of the secure service for allowing the server to confirm the identity of the user (and/or client computer); authentication of the server providing the secure service for allowing the user to confirm the identity of the server; and encryption of the communication channel between the server and the client computer, which is especially necessary when a high degree of confidentiality is required such as during a private transaction, or when messages need to be digitally signed.

Generally, the first of these three concerns, namely the authentication of the user, is the most challenging. Users usually identify themselves to servers by providing a “username” or “user number”. Since usernames and numbers are generally not kept secret, it would be relatively easy for an intruder to pose as another user and gain access to that user's secure service(s). To prevent this from happening, the identity of the user must be authenticated. User authentication is usually done in one of three ways. The first is knowledge of confidential information, such that if the user can show that he or she is in possession of certain confidential information such as a password, a personal identification number (PIN), a cryptographic key or a certificate, which only the real user is supposed to know, it may act as proof of identity. Secondly, if the user can show that he or she is in possession of a hardware device or token, such as a magnetic card, a smart card, a cryptographic token or calculator, which only the real user is supposed to have, again this may act as proof of identity. Finally, if the user can show that a measurement of a part of his or her body, such as a fingerprint, a retina scan or a photograph, matches that of the real user, this may also act as proof of his or her identity.

However, user authentication based on secret, confidential information is generally considered to be a weak authentication method because users are known to choose weak, easy-to-guess passwords, or to write down passwords, or to even share passwords. Furthermore, the user is never totally sure that a third party does not know his or her secret, confidential information.

Authentication systems and methods based on hardware tokens and biometric measurements are considered to be relatively “strong” because the identity of a user cannot be falsely authenticated by, for example, guessing confidential information. For token-based authentication, the user can be assured that as long as he or she is in possession of the hardware token, access to his or her secure services by a third party is impossible. For biometric-based authentication where the biometric measurement is encoded into some electronic format that is transmitted over open communication channels, this information must be encrypted to preserve its secrecy and prevent unauthorized use by an imposter. Although this is generally a very secure authentication system and method, it does require significant logistical and computational overheads associated with the encryption techniques.

The existing “strong” methods of authenticating users suffer from two practical problems, namely a distribution problem and a registration problem. The distribution problem refers to the difficulty of “rolling out” the user authentication technology. In all cases, either secret keys, hardware tokens such as cryptographic tokens and calculators, software programs or devices such as card readers and biometric scanners must be distributed to all the users. Usually there are many more users than servers, and where the servers may be centrally located, users are usually widely distributed. This creates logistical problems where, due to the difficulty of distributing the necessary software and/or devices to the users, the implementation and maintenance of these authentication systems are in many cases expensive and impractical. This is particularly true where the user base is large, for example, where users from among the general public make use of online Internet-based subscription services including, but not limited to, Internet banking, access to electronic media and literature, insurance services, stockbrokerage, investment and other financial services, health services, as well as other online technologies such as e-commerce as well as the submission of electronic forms such as for tax returns, for example.

Turning now to the registration problem mentioned above, all “strong” user authentication mechanisms use a database to match usernames or numbers with a cryptographic key, retina pattern, hardware token serial number, etc. The registration problem refers to the difficulty in populating the authentication database with correct information. If the initial registration of information into this database is not a trustworthy process, the security of the authentication method is undermined. The registration problem is particularly evident when users from a large user base, such as from among the general public, need to be authenticated for online services such as those listed above. A particularly advantageous feature of any authentication system and method, particularly for Internet applications, would be the ability to authenticate users who have not yet registered for the authentication service, or at least to enable the user to register online in order to make immediate use of secure online services.

For large, widely-distributed user bases making use of publicly-accessible, secure computer-based services which are centrally located, strong user authentication is a challenging problem to solve. Strong authentication of servers, especially where these servers are few and centrally located, can be solved in a practical and secure way by existing methods that are not affected by the distribution and registration problems. These methods typically utilise public-key cryptography (such as SSL), where public keys located on servers provide both strong authentication of the server to the user, as well as secrecy during the transaction. However, there still remains the residual problem of implementing practical, strong user authentication.

### SUMMARY OF THE INVENTION

According to a first aspect of the invention there is provided an authentication system for authenticating the identity of a user wishing to access a facility, the system comprising:

control means;

a database that includes user identification information, the database being accessible by the control means;

password generating means for generating a passcode, the passcode generating means being controlled by the control means;

a first communications network between the user and the facility for providing the facility with the user identification information and the passcode;

a second communications network between the facility and the control means for receiving an authentication request and for allowing the control means to provide the facility with the passcode;

a third communications network between the user and the control means for sending the same passcode that was sent by the control means to the facility, to the user, for allowing the user to send the passcode to the facility via the first communications network; and

comparing means for allowing the facility to compare the passcode received from control means with the passcode received from the user so as to allow the user to access the facility in the event of there being match in the passcodes.

Typically, wherein the control means, the database that includes user identification information and the passcode generating means are situated at a centralized authentication server.

Preferably, the comparing means is situated at the facility, thereby allowing the facility to make a final decision as to whether to allow the user access to the facility.

Conveniently, the third communications network is a cellular communications network with the database including at least the user's name or an identification number and an associated cellular communication device contact number. Typically, the third communications network is a GSM-based cellular network.

Advantageously, the authentication system includes a confidence value generating means for generating a confidence value reflecting the integrity of the authentication system, the confidence value being sent to the facility together with the passcode via the second communications network.

Typically, the authentication request includes the user identification information and a server name or address.

In one form of the invention, the passcode is a random number. Alternatively, the passcode is a cryptographic digest of a message sent by the user to the facility, the system thereby also allowing authentication of the message sent by the user.

Preferably, the authentication system includes session number generating means for generating a session number, the session number being sent to both the facility and the user via the second and third communications networks respectively, so as to allow the facility and the user to match the received passcode with the correct authentication session.

Typically, the authentication system includes logging means for logging each attempted authentication session so as to form an audit trail.

Advantageously, the third communications network is selected from the group comprising a local area network (LAN), a wide area network (WAN) and the Internet.

According to a second aspect of the invention there is provided an authentication method for authenticating the identity of a user wishing to access a facility, the method comprising the steps of:

prompting the user to provide the facility with user identification information;

sending a request for authentication from the facility to a third party;

generating a passcode;

providing the passcode to the facility and to the user;

prompting the user to provide the facility with the passcode; and

comparing the passcode received by the user to the passcode received by the third party; and

allowing access to the facility in the event of there being a match between the two passcodes.

Preferably, the step of providing the user with the passcode includes the step of transmitting the passcode over a cellular communications network.

Typically, the method includes the step of generating a session number, the session number being sent to both the facility and the user so as to allow the facility and the user to match the received passcode with the correct authentication session.

Advantageously, the method includes the step of generating a confidence value reflecting the integrity of the authentication method, the confidence value being sent to the facility together with the passcode.

Preferably, the step of the facility requesting authentication from a third party includes the steps of providing the third party with the user identification information and a server name or address.

In one form of the invention, the step of generating a passcode includes the step of generating a random number. Alternatively, the step of computing a passcode includes the step of generating a cryptographic digest based on a message sent by the user to the facility.

Preferably, the method includes the step of logging each attempted authentication session so as to form an audit trail.

### BRIEF DESCRIPTION OF THE DRAWING

The only drawing shows a schematic view of the authentication process and system according to the present invention.

### DESCRIPTION OF THE PREFERRED EMBODIMENT

Referring to the drawing, the authentication system 10 of the invention allows the identity of a user 12 to be authenticated when the user 12 is seeking access to a secure service that is hosted on one of a plurality of internet protocol (IP) servers 14. The IP servers 14 correspond to the computer system 16 that provides the secure service over an IP network, and may be a file server, mail server, print server, remote access server, web server, or any other suitable server. The user 12, typically via his or her computer 18, interacts with the IP servers 14 via an IP network 20, which in broad terms relates to any communication infrastructure through which the user 12 can access the IP servers 14. Typically, the IP network 20 will take the form of a local area network (LAN), a wide area network (WAN) or the Internet.

The authentication system 10 includes an authentication server 22, which is a centralized computer system 24 that performs most of the authentication used in the present invention. The authentication server 22 is able to provide an authentication service to many IP servers 14, and this ensures that the present invention can be implemented on a broad basis.

The authentication system 10 of the present invention makes use of a user database, which is provided at the authentication server 22 or at a separate, dedicated database server. The primary purpose of the user database is to match the name of the user 12 with an associated mobile communication device network number. The user 12 database can be populated by an administrator, or by the users themselves. However, when users 12 register on the user database, the correctness of the information must be confirmed from third party sources such as databases of mobile communication network service providers, banks or any other trustworthy source of information.

A crucial element of the present invention is the provision of two separate communication channels, the first being the IP network 20 described above. The second channel is a mobile communications channel 26 that utilises a mobile communication device 28 that will allow the authentication server 22 to communicate with the user 12. At present, it is envisaged that the phrase “mobile communication device” 28 is meant to include, but not be limited to, cellular telephones operating with a valid SIM card, pagers and beepers. In essence, though, any mobile device 28 that can be used to communicate and which is registered against the name of the user 12 can be used as proof of the identity of the user 12 or person trying to access the secure service. This communication infrastructure will typically be a GSM cellular network. Thus, this mobile communication infrastructure is used as a separate communication channel, and is used to provide the user 12 with a one-time passcode during the authentication process, as will be explained in detail further below.

The passcode can be either a random number, or can be a cryptographic digest of the information offered by the user. In the case of the cryptographic digest, the passcode forms an authentication signature of the contents of the message.

The IP servers 14, which refers to all servers that make use of the authentication system 10 of the present invention, make use of software, also known as a “thin authentication client”. This software redirects the authentication process, which would typically have taken place at the IP server 14 itself, to the authentication server 22.

The authentication system 10 thus uses a mobile communication device 28 as an authentication token to authenticate the identity of a user 12 trying to gain access to a computer/network service 14 and/or the contents of a message provided by the user. There are two main steps that are used in the authentication process, namely registration and the actual authentication.

In the registration process, the user's details, including, but not limited to, a username or number and his or her mobile communication device network number, such as a mobile telephone number, are registered in the user database. For employees of a company, this can be done by the system administrator and does not need confirmation from third-party sources outside the company. For online Internet services where users from among the general public can register online, the details submitted by the user to the database must be confirmed by another source. This is done by asking the user to fax and/or post information such as mobile telephone account statements, credit card statements, etc, and/or by querying other databases such as those from mobile communication network service providers and banks. Every time the information is confirmed, a confidence value reflecting the integrity of the confirmation method is adjusted and updated in the database.

The actual process involved in authenticating a user 12 and/or the contents of the information offered by the user will now be described. The process commences with the user 12 requesting access from his or her computer 18, via the IP network 20, to the desired service 16 that in turn is a subscriber to the authentication system of the invention, by sending his or her username or number to the IP server 14 via the IP network 20. The user may optionally add additional information, such as account details and amounts during a commercial transaction, for example, as part of the request for access to services. This step is shown in general by 30. The IP server 14 then generates a request for confirmation of the user's identity, which it then sends to the authentication server, as indicated by 32. The request includes the username and server name or address as well as any extra information the user may have offered.

The authentication server 22 then generates a random number or computes a cryptographic digest, based on the information offered by the user, with either the random number or the cryptographic digest being referred to as a passcode, as well as a session number. The authentication server 22 then also queries the user database for the mobile communication device network number of the user 12, and sends the passcode and session number via the mobile communication network to the user's mobile communication device 28. This step is indicated by 34, and can be done by using any one of a number of suitable GSM messaging services, such as SMS, USSD, GPRS, as well as pager/beeper messaging services. The device for sending this information to the user is indicated generally by 36.

The same passcode, session number, as well as a confidence level are sent to the IP server 14, as shown by 38. However, a different passcode is used for every new access attempt, with the passcode only being valid for a limited period of time.

Once the user 12 receives the passcode by his or her mobile communication device 28, he or she offers it, via the IP network 20, as a passcode to gain access to the secure service offered by the IP server 14. This is shown at 40. The passcode, which is typically in the form of a random number or a cryptographic digest, is generated in a cryptographically secure manner, and is used only once for a single, unique login session. The IP server 14 then compares the passcode that was offered by the user via the IP network 20 with the passcode that was generated for that particular login session by the authentication server 22. If the two codes are the same, it is concluded that the user 12 is in possession of the authentication token, typically the GSM SIM card, and can therefore positively be identified as the user whom he or she claims to be. If a cryptographic digest was computed, this digest, when logged, forms a signature, which can be used to confirm the authenticity of the information offered by the user. If, however, the numbers do not match, or if a response is not received within a certain time interval, access is denied.

A level of confidence, which is derived from a method used to confirm the user's details in the database, is returned to the provider of the service where it may be used to determine whether or not to grant access to the user. The confidence level is a numerical value that is assigned according to the procedure by which the details of user 12 are registered in the user database. For example, numerical values between 0 and 100 may be assigned to the user 12 in such a manner: if the user's data are registered online via the Internet by the user him/herself, a confidence level of 0 is assigned, indicating the lowest level of confidence. If, however, the user submits copies of documents, such as mobile telephone account statements, credit card statements, etc, via fax, a confidence level of 10, for example, may be assigned. Submission of original documents by post, or proof of possession of original documents in person, may further increase the confidence level. The highest confidence level, 100 in this case, could be assigned if original documents, together with required identification, are provided in person, and this information can be verified by querying other databases such as those from mobile communication network service providers and banks. Advantageously, therefore, it is the provider of the service or facility who ultimately needs to decide whether or not to grant access to the service or facility.

The outcome of the access attempt is sent back to the authentication server 22 and logged in the user database, as indicated by 42.

The passcode can also be combined with a password or a PIN number to form a stronger two-factor authentication system.

Each step in the authentication process is logged to form an audit trail that can serve, for example, as evidence that a specific user has indeed used the service. Thus, a user would not be able to deny that he or she used a certain service if access to that service was granted after providing, within a limited period of time, a passcode that was sent to his or her mobile communication device during a period for which the mobile communication device was not reported missing. In the case of the passcode being based on a cryptographic digest of the information offered by the user, the logged passcode acts as a signature and confirmation of the contents of the information offered by the user. Thus a user cannot later deny having offered that information. The cryptographic transformation of only the correct information will result in a match with the logged passcode.

It is envisaged that in one form of the invention the registration and authentication processes above could be combined by asking the user for all the registration details during every authentication process.

Every login session or access attempt is numbered with a pseudo-unique number, known as the session number. When the authentication server sends a message containing the passcode via the mobile communication network to the user's mobile communication device, it also includes the Session Number. The thin authentication client, or the software on the IP server, uses the same session number when prompting the user for the passcode. This enables the user to match the received passcode with the correct login session.

The authentication system thus provides a practical way to authenticate the identity of users of computer systems for applications including, but not limited to:

1. Dial-up Remote Access

Access by authorized employees or external support personnel to corporate LANs/WANs via a remote-access dial-up connection. Thus, remote dial-up access can potentially open up the corporate LAN/WAN to any person world-wide, and hence secure user authentication is critical in order to confirm the identity of personnel trying to gain access.

2. Operating Systems

Access by authorized employees or external support personnel to corporate computer systems via, but not limited to, Telnet, RLOGIN, RSH, and X-Windows.

3. Application Software

Access by authorized employees or external support personnel to corporate computer applications including, but not limited to, databases, FTP, E-mail, etc.

4. Web-based Online Internet Subscription Services

Access to financial services such as internet banking and investment portals, online medical scheme services, online insurance and stockbrokerage services, electronic media and literature.

5. E-commerce

For online credit card transactions, where credit card issuers will not accept the risk of fraud and charge losses back to the merchants, authenticating the identity of the user conducting the transaction provides an important business advantage. When using a cryptographic transformation on the information offered by the user, as passcode, the authenticity of information such as the transaction amounts and account numbers can be logged and shown.

The authentication system of the present invention thus provides a “strong” and secure user authentication by using the user's cellular telephone SIM card as an authentication token. In addition, the fact that a cryptographically secure random number or passcode is sent via a separate channel to the user's cellular telephone ensure that only the user in possession of the GSM SIM card can successfully authenticate his or her identity. Since every passcode is used once only, it cannot be re-used by an intruder. Furthermore, a two-factor authentication mechanism results if the system is used in conjunction with a password or PIN number, which, it is envisaged, would be the preferred way in which the system would be used.

In particular, the disclosed system also addresses the distribution problem described above in that it uses existing cellular phones. In addition, by confirming user details from existing databases, the registration problem is also addressed.

In addition, the present, which makes use of existing infrastructure, such as hardware tokens and databases, is particularly suitable for applications that require secure authentication of users from large user bases, such as from among the general public.

1. An authentication system for authenticating the identity of a user wishing to access a facility, the system comprising:
control means;
a database that includes user identification information, the database being accessible by the control means;
passcode generating means for generating a passcode, the passcode generating means being controlled by the control means;
a first communications network between the user and the facility for sending the user identification information and the passcode from the user to the facility;
a second communications network between the facility and the control means for sending an authentication request from the facility to the control means and for allowing the control means to provide the facility with the passcode; and
a third communications network between the user and the control means for sending the same passcode to the user for allowing the user to send the passcode to the facility via the first communications network,
so that the facility can compare the passcode received from the control means with the passcode received from the user so as to allow the user to access the facility in the event of there being a match in the passcodes, such a match being valid once only.

2. An authentication system according to claim 1 wherein the control means, the database that includes user identification information and the passcode generating means are situated at a centralized authentication server.

3. An authentication system according to either one of the preceding claims wherein the comparing means is situated at the facility, thereby allowing the facility to make a final decision as to whether to allow the user access to the facility.

4. An authentication system according to any one of the preceding claims wherein the third communications network is a cellular communications network with the database including at least the user's name or an identification number and an associated cellular communication device contact number.

5. An authentication system according to claim 4 wherein the third communications network is a GSM-based cellular network.

6. An authentication system according to any one of the preceding claims that includes a confidence value generating means for generating a confidence value reflecting the integrity of the authentication system, the confidence value being sent to the facility together with the passcode via the second communications network.

7. An authentication system according to any one of the preceding claims wherein the authentication request includes the user identification information and a server name or address.

8. An authentication system according to any one of the preceding claims wherein the passcode is a random number.

9. A message authentication system according to any one of claims 1 to 7 wherein the passcode is a cryptographic digest of a message sent by the user to the facility, the system thereby also allowing authentication of the message sent by the user.

10. An authentication system according to any one of the preceding claims that includes session number generating means for generating a session number, the session number being sent to both the facility and the user via the second and third communications networks respectively, so as to allow the facility and the user to match the received passcode with the correct authentication session.

11. An authentication system according to any one of the preceding claims, which includes logging means for logging each attempted authentication session so as to form an audit trail.

12. An authentication system according to any one of the preceding claims wherein the first and/or second communications network is selected from the group comprising a local area network (LAN), a wide area network (WAN) and the Internet.

13. An authentication method for authenticating the identity of a user wishing to access a facility, the method comprising the steps of:
the facility prompting the user to provide the facility with user identification information;
the facility sending a request for authentication to a control means;
the control means generating a passcode;
the control means providing the same passcode to the facility and to the user;
the facilitating prompting the user to provide the facility with the passcode;
the facility comparing the passcode received from the user to the passcode received from the control means; and
allowing access to the facility in the event of there being a match between the two passcodes.

14. An authentication method according to claim 13 wherein the step of providing the user with the passcode includes the step of transmitting the passcode over a cellular communications network.

15. An authentication method according to either one of claims 13 or 14, which includes the step of generating a session number, the session number being sent to both the facility and the user so as to allow the facility and the user to match the received passcode with the correct authentication session.

16. An authentication method according to any one of claims 13 to 15 that includes the step of generating a confidence value reflecting the integrity of the authentication method, the confidence value being sent to the facility together with the passcode.

17. An authentication method according to any one of claims 13 to 16 wherein the step of the facility requesting authentication from a third party includes the steps of providing the third party with the user identification information and a sever name or address.

18. An authentication method according to any one of claims 13 to 17 in which the step of generating a passcode includes the step of generating a random number.

19. An authentication method according to any one of claims 13 to 17 in which the step of computing a passcode includes the step of generating a cryptographic digest based on a message sent by the user to the facility.

20. An authentication method according to any one of claims 12 to 19 which includes the step of logging each attempted authentication session so as to form an audit trail.
